(19) United States
(12) Patent Application Publication
(10) Pub. No.: US 2016/0070924 A1
(43) Pub. Date: Mar. 10, 2016

(54) Virtual-Account-Initiated Communication of Protected Information

(71) Applicant: WebMD Health Corporation, New York, NY (US)

(72) Inventors: Bassam A. Saliba, Kirkland, WA (US); John Yii, Newcastle, WA (US); Nicholas M. Altebrando, Long Island City, NY (US); Gopal Annasundaram, Sammamish, WA (US); Danh T. Vo, Renton, WA (US)

(21) Appl. No.: 14/480,110

(22) Filed: Sep. 8, 2014

(51) Int. Cl. G06F 21/62; H04L 29/06; G06F 19/00

(52) U.S. Cl. CPC G06F 21/6245; G06F 19/322; H04L 63/04

(57) ABSTRACT

Described herein are techniques for receiving a first communication sent to a virtual account address and sending a second communication to a recipient communication address. The virtual account address may include the recipient communication address in a user name part of the virtual account address, and the second communication may invite its recipient to request creation of a secure electronic message account. The recipient may then receive content associated with the first communication via the secure electronic message account.

### BACKGROUND

Despite the availability of many kinds of content and information to users through wired and wireless networks, electronic copies of medical records and other patient-specific health information are often very difficult for patients to obtain. Some medical service providers maintain only paper copies of certain medical records, and others maintain utilize electronic health records that are not available to patients over a network. A smaller number of medical service providers do allow patient access to medical records over a secured network connection, but even then such providers typically require a patient to report in person to a medical service provider facility in order to obtain a code that is used for the network access. Even after doing this, the patient typically receives only the medical records and information generated by that medical service provider.

To address many of these issues, the National Health Information Network initiated the Direct Project. The Direct Project specifies a secure, standards-based technique for medical record communication between patient and medical service provider. Any patient who has already established a Direct Project email account (also referred to as a “Direct email account”) may give the email address for that account to the medical service provider, and the medical service provider may send medical records to that email address.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an overview of an account creation service that may be configured to receive a first communication to a virtual account address, to determine a recipient address within a user name part of the virtual account address, and to send a second communication to the recipient address inviting the recipient to request creation of a secure electronic message account.

FIG. 2 illustrates a component level view of a computing device of the account creation service.

FIG. 3 illustrates a component level view of a computing device of a recipient or a medical service provider.

FIG. 4 illustrates an example process for receiving a first communication to a virtual account address and sending a second communication to a recipient communication address that was included in the virtual account address.

FIG. 5 illustrates an example process for receiving a communication inviting its recipient to request creation of a secure electronic message account to receive a medical record, requesting creation of the secure electronic message account, receiving a validation challenge, providing an answer to the validation challenge, and receiving the medical record through the secure electronic message account.

FIG. 6 illustrates an example process for creating a patient communication that invites the patient to create a secure electronic message account to receive patient medical information, enabling a medical service provider to send the patient communication, creating the secure electronic message account responsive to patient input, and providing the patient medical information to the patient via the secure electronic message account.

FIG. 7 illustrates an example process for a print driver to receive content that includes a communication address, to retrieve the communication address from the content, and to send the content in a secure communication to a virtual account address that include the communication address in a user name part of the virtual account address.

### DETAILED DESCRIPTION

This disclosure describes, in part, techniques for receiving content, such as medical information, for a recipient before the recipient has created a secure electronic message account. Upon receiving the content, a message may then be sent to a communication address of the recipient inviting the recipient to request creation of the secure electronic message account. Once the secure electronic message account is created, the content may be sent to the recipient via the secure electronic message account. In some examples, the communication address of the recipient may be obtained from the user name part of a virtual account address. The content may initially be communicated by a sender, such as a medical service provider, that sends a secure communication to the virtual account address. In further examples, the communication address may be obtained from the medical information.

Upon receiving a message inviting the recipient to request creation of a secure electronic message account to view content intended for the recipient, the recipient may request creation of the secure electronic message account. The recipient may then be requested to answer a validation challenge to provide evidence that the recipient is the intended recipient of the content. Following validation, the recipient may receive the content via the secure electronic message account.

### Overview

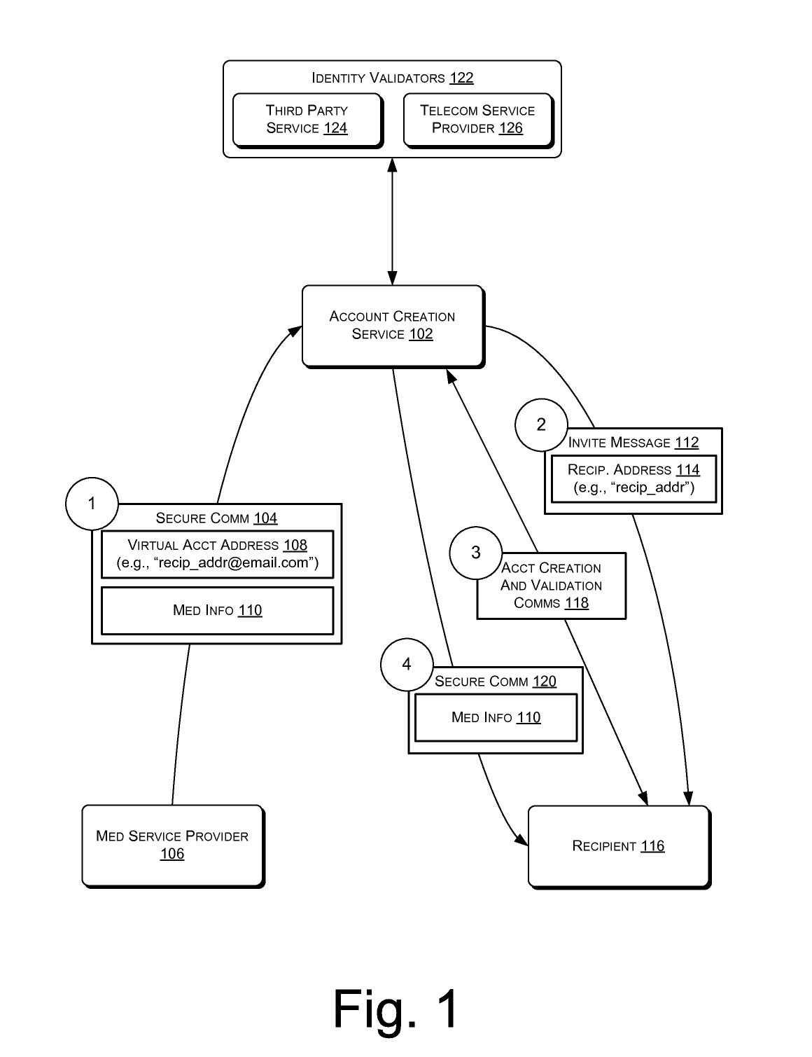

FIG. 1 illustrates an overview of an account creation service that may be configured to receive a first communication to a virtual account address, to determine a recipient address within a user name part of the virtual account address, and to send a second communication to the recipient address inviting the recipient to request creation of a secure electronic message account. As illustrated, an account creation service 102 may receive a secure communication 104 from a medical service provider 106. The secure communication 104 may be addressed to a virtual account address 108 and include content, such as medical information 110. Upon receiving the secure communication 104, the account creation service 102 may send an invite message 112 addressed to a recipient address 114 of a recipient 116. After receiving the invite message, the recipient 116 may engage in account activation and validation communications 118 with the account creation service 102. The account creation service 102 may then create a secure electronic message account for the recipient 116 and send a secure communication 120, including the medical information 110, to the secure electronic message account address. In some examples, the account creation service 102 may utilize identity validators 122, such as a third party service 124 or a telecommunication service provider 126, to validate the identity of the recipient 116 before creating the secure electronic message account. In further examples, the recipient 116 may be a medical service provider and the secure communication 104 may be received from a patient, from another medical service provider 106, or from another party.

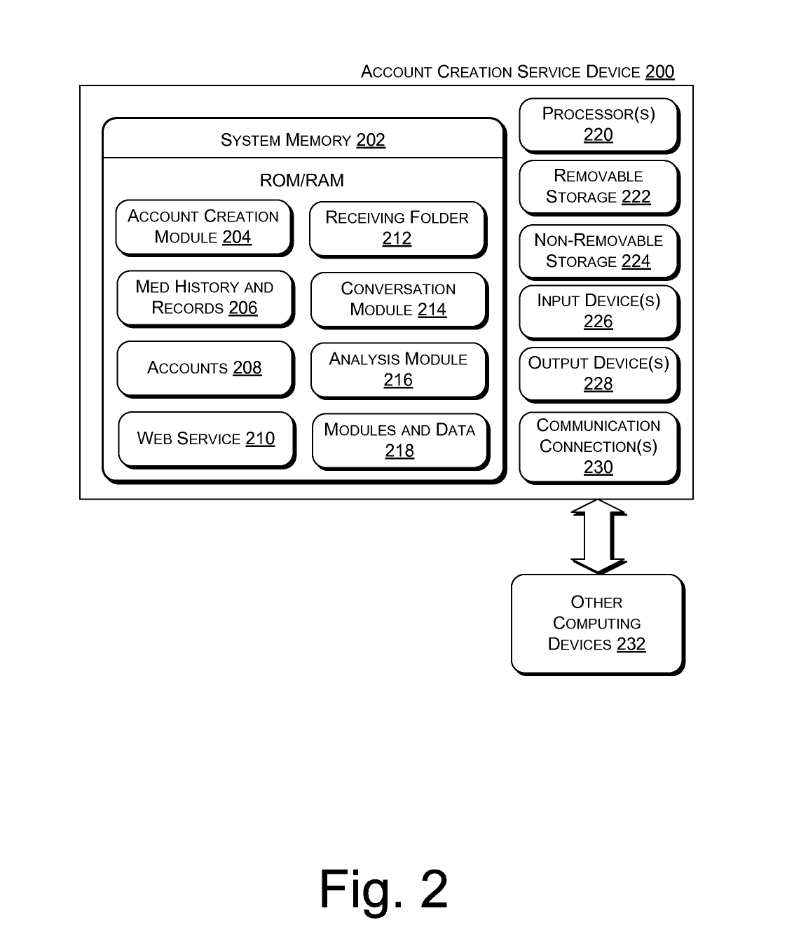

In various examples, the account creation service 102 may be implemented by one or more computing devices. Such computing device(s) may each be or include a server or server farm, multiple, distributed server farms, a mainframe, a work station, a personal computer (PC), a laptop computer, a tablet computer, an embedded system, or any other sort of device or devices. In one implementation, the computing device(s) include a plurality of computing devices working in communication, such as a cloud computing network of nodes. An example computing device of the account creation service 102 is illustrated in FIG. 2 and is described in detail below with reference to that figure.

Further, the account creation service 102 may be associated with services provided to medical service providers, patients, and persons responsible for the care of patients (“responsible persons”). These services may include the creation of secure electronic message accounts, the secure transmission of medical information, such as medical records, between medical service providers and patients or responsible persons, and the maintenance of medical records, medical histories, and other medical information. In some examples, the account creation service 102 may maintain medical information and communications from multiple medical service providers 106 on behalf of a patient or responsible person.

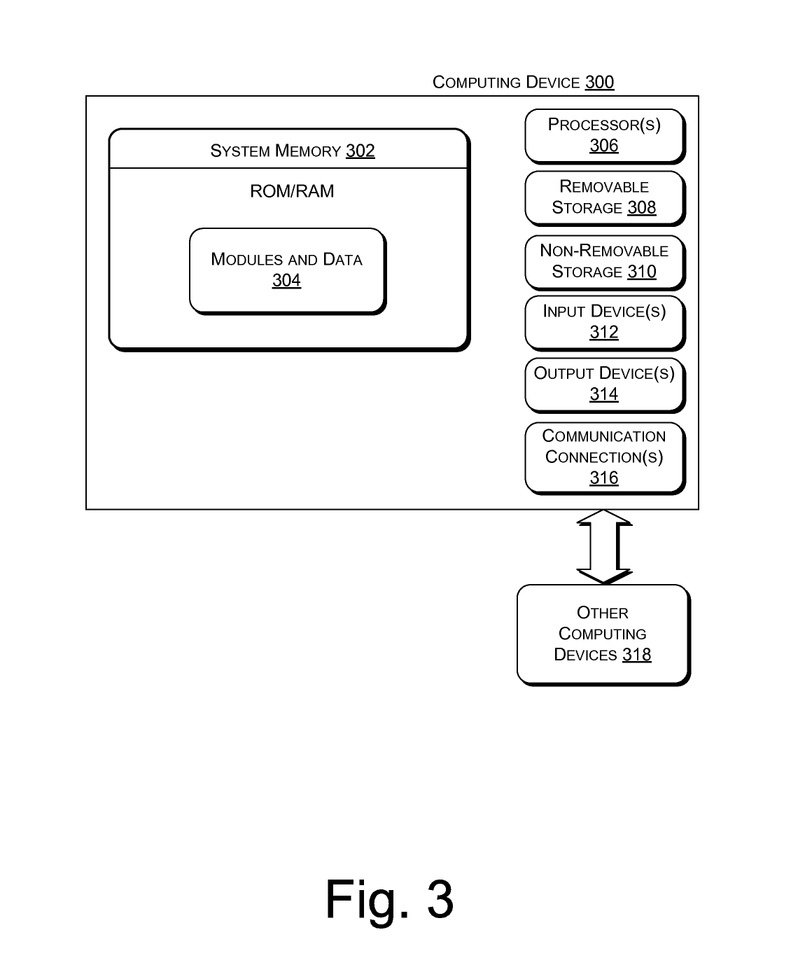

In further examples, the medical service provider 106 and recipient 116 may each be associated with one or more computing devices. Such computing device(s) may each be or include a server, a work station, a PC, a laptop computer, a tablet computer, a cellular phone, a smart phone, a media player, an electronic reading device, an office device, a printer, a scanner, a photocopier, an embedded system, or any other sort of device or devices. In one implementation, the computing device(s) include a plurality of computing devices working in communication, such as a cloud computing network of nodes. An example computing device of the medical service provider 106 or recipient 116 is illustrated in FIG. 3 and is described in detail below with reference to that figure.

The medical service provider 106 may include any physician or care team member, such as a doctor, a physician's assistant, a nurse, a dentist, a hygienist, a nutritionist, a psychologist, a physical therapist, a lab worker, a medical technician, a pharmacist, a person assisting any of these care providers, or any other sort of person working in the medical field. The recipient 116 may be a patient, a responsible person for a patent, or another medical service provider. Any patient may have one or more medical care providers 106, which may each also have separate electronic health records and repositories of medical information.

In some examples, the account creation service 102 may be connected to the medical service provider 106 and the recipient 116 by one or more networks. Such network(s) may include wired network(s), wireless network(s), or any combination of wired and wireless network(s). The network(s) may also be public network(s), private network(s), or any combination of public and private network(s). Further, the network(s) may include the Internet, wide area networks (WANs), local area networks (LANs), personal area networks (PANs), or any combination of the Internet, WANs, LANs, or PANs. Additionally, the network(s) may include telecommunication network(s), such as cellular network(s).

In various examples, the medical service provider 106 (or patient or other sender—the medical service provider, patient, or other sender are hereinafter referred to as the “medical service provider 106”) may send a secure communication 104 to the account creation service 102. The secure communication 104 may be an electronic message or a secure web service call. For example, the secure communication 104 may be secured in accordance with the secure, standards-based technique specified by the Direct Project, or in accordance with some other security protocol or security technique.

The secure communication 104 may be addressed to a virtual account address 108, which may be an electronic message address. The user name part of the virtual account address 108 may be the recipient address 114. Examples of such recipient addresses 114 may include phone numbers, electronic message addresses (also referred interchangeably as “email addresses”), fax numbers, or social media identifiers. When the recipient address 114 is an email address, the medical service provider 106 may specify a transformed email address in place of the email address. For example, if the email address is “joe.smith@email.com,” the transformed email address may be “joe.smith!!!email.com.” The resulting virtual account address 108, which incorporates the recipient address 114, may then, for example, be of a form such as “joe.smith!!!email.com@secure.email.com” or “4253219876@ secure.email.com.” While the virtual account address 108 may not correspond to an existing email address or email account, the account creation service 102 may receive the secure communication 104 directed to such a virtual account address as if the virtual account address 108 does correspond to an existing email address or email account. The virtual account address 108 may be entered by personnel of the medical service provider 106 when the personnel draft the secure communication 104 or may be specified by software, such as a print driver, of a computing device of the medical service provider 106.

In some examples, the secure communication 104 includes any sort of content, such as medical information 110. Medical information 110 may be a medical record, a prescription, medical advice, a medical appointment reminder, or any sort of other medical-service-related communication. Such medical information 110 is transmitted in secured communications, such as secure communication 104 and secure communication 120, rather than in unsecured communications.

In further examples, the medical service provider 106 may capture a photo or biometric of the patient or responsible person during a visit to an office of the medical service provider 106. Such a photo or biometric may also be transmitted with the secure communication 104 to aid in validating that the recipient 116 is the patient or responsible person.

Upon receiving the secure communication, the account creation service 102 may determine the recipient address 114 included in the virtual account address 108 and may send an invite message 112 to the recipient address 114. The account creation service 102 may also store either or both of the secure communication 104 or the medical information 110 included in the secure communication, and any other information included in the secure communication 104 (e.g., photo, biometric, etc.). The invite message 112 may be any of a text message, an electronic message, a fax, a web portal, or a direct notification to a mobile application.

When the invite message 112 is a text message or electronic message, the invite message may include a link that, when interacted with, launches a web portal or a mobile application. The recipient 116 then interacts with the web portal to request creation of the secure electronic message account. When the invite message 112 is a fax, the invite message 112 may include a bar code representing a unique encrypted code which a recipient 116 may scan with a device or enter into a web portal in order to request creation of a secure electronic message account. When the invite message 112 is a web portal, such as a web portal associated with a social networking identifier, the user may interact with a notification included in the invite message 112 to launch a further web portal for requesting creation of the secure electronic message account.

In some examples, prior to delivering the invite message 112, the account creation service 102 may send an interactive voice recording (IVR) message to a phone number of the recipient 116. The recipient 116 may then speak or key-press an electronic message address for the recipient 116, which may result in the account creation service 102 sending an invite message 112 to that electronic message address. In other examples, the IVR may direct the recipient 116 to visit a web portal to enable the recipient 116 to request creation of a secure electronic message account. IVR may be used when the recipient address 114 is a phone number and when text messaging is not available for that phone number. Alternatively, IVR may also be used when text messaging is available.

In various examples, the account creation service 102 may then engage in account creation and validation communications 118, including one or more of an account creation request 118, a validation challenge 118, and a validation response 118. The account creation service 102 may receive a request 118 for creation of the secure electronic message account through a web portal or other mechanism, such as a reply email or text message from the recipient 116. The web portal or other mechanism for submitting the request may, in some examples, include fields for the recipient 116 to provide information. Such information could include a user name part for the secure electronic message account address (e.g., “joe.smith” for “joe.smith@secure.email.com”) and a password. The fields may also enable the recipient 116 to specify any of a name, a gender, a date of birth, an address, a zip code, medical history information, other private information.

Once the account creation service 102 receives the account creation request 118, the account creation service 102 may validate the identity of the recipient 116. Such validation may be based on information, based on the attestation of others (e.g., the medical service provider 106, identity validators 122, etc.), or both.

For instance, if the account creation request 118 includes information entered by the recipient 116 (e.g., name, gender, date of birth, address, zip code, medical history information, other private information, etc.), the account creation service 102 may compare that information to the medical information 110, to other medical history/records for the patient referenced in the medical information, or to both. If the information matches, the account creation service 102 may deem the identity validated and create the secure electronic message account.

In other examples, the account creation request 118 may not include the information entered by the recipient 116 or may only include insufficient information for validating the identity of the recipient 116. In such examples, the account creation service 102 may send a validation challenge 118 asking the recipient 116 to provide additional information (e.g., name, gender, date of birth, address, zip code, medical history information, other private information, etc.) in a validation response 118. If the information in the validation response 118 matches, the account creation service 102 may deem the identity validated and create the secure electronic message account.

In further examples, the account creation service 118 may have a photo or biometric of the patient (e.g., from the secure communication 104 or from medical history/records), and the recipient 116 may provide a photo or biometric in the account creation request 118 or in a validation challenge response 118. In such examples, if the photos or biometrics match, the account creation service 102 may deem the identity validated and create the secure electronic message account.

Also or instead, the account creation service 102 may seek validation of the identity of the recipient 116. For instance, if the account creation service 102 lacks sufficient information to compare to the information provided by the recipient 116 in the account creation request 118 or validation challenge 118, the account creation service 102 may provide all or a subset of the information provided by the patient (or other recipient 116) to another to ask that other to validate the recipient 116. The account creation service 102 could provide the information to the medical service provider 106, for example, to ask the medical service provider 106 to attest that the information indicates that the recipient 116 is the intended recipient of the medical information 110. The account creation service 102 could also or instead provide the information to a third party service 124 which may use that information to validate the identity of the recipient 116. Further, the account creation service 102 could perform a carrier phone number lookup with a telecommunication service provider 126 to validate the identity of the recipient 116. Upon receiving validation from the medical service provider 106, the third party service 124, the telecommunication service provider 126, or another identity validator 122, the account creation service 102 may deem the identity validated and create the secure electronic message account.

In various examples, upon creating the secure electronic message account, the account creation service 102 may create a secure communication 120 addressed to the secure electronic message account and include the medical information 110 with the secure communication 120. For example, the secure communication 120 may be secured in accordance with the secure, standards-based technique specified by the Direct Project, or in accordance with some other security protocol or security technique.

Various example scenarios illustrate uses to which the system of FIG. 1 may be put. In a first example scenario, a person (the recipient 116) may visit her doctor (the medical service provider 116) and have a blood test done. While at the doctor, the person may indicate that she would like to receive her blood test results electronically. She may not, however, have a secure electronic message account to which the results may be sent. Her doctor or other medical staff may ask for her phone number or email address. Once the results are ready, the doctor may then send an email (secure communication 104) to a virtual account address (virtual account address 108) for the patient, including the blood test results (medical information 110) with the email. This virtual account address utilizes the phone number or a transformed version of the email address (i.e., version of the email address with the ‘@’ replaced or removed) as a user name part followed by an ‘@’ and a domain part (e.g., “secure.email.com”). A service (account creation service 102) receiving the email from the doctor may then send a text message (invite message 112) to the patient phone number (recipient address 114) or an email (invite message 112) to the patient email address (recipient address 114) inviting the patient to request creation of a secure electronic message account in order to receive the blood test results. The patient may request (communication 118) creation of the secure electronic message account, and the blood test results may then be sent in an email (secure communication 120) to that account.

In another scenario, rather than the doctor drafting an email to the virtual account address, the doctor may scan, copy, or print the blood test results, and a print driver of the device performing the scanning, copying, or printing may detect a phone number or email address of the patient in a patient information section of the results and may create an email to the virtual account address, attach the blood test results to that email, and send the email to a service.

In a further scenario, while visiting the doctor, the doctor or medical staff may take a photo or biometric of the patient and may provide her photo or biometric along with the email of the blood test results. The service creating the secure electronic message account for the patient may then use that photo or biometric in validating her identity.

In another scenario, rather than the doctor drafting an email to the virtual account address, the doctor may provide the blood test results in some fashion to the service. This may simply involve adding the blood test results to medical records of the patient or may involve sending a communication to the service. The service may then determine a communication address for the patient via a matching algorithm, such as her phone number or email address, and may create a text message or email for the doctor to elect to send to the patient. This created text message or email for the patient may be placed in a receiving folder for the doctor and the doctor may view a user interface representing the messages in the receiving folder. The doctor may then select one or more of the messages to be sent to invite their associated patients to create secure electronic message accounts. The purpose for allowing the doctor to review and approve is, among other things, to provide the doctor the option to validate the matching.

In a further scenario, the patient may have previously created a secure electronic message account for her child and provided her phone number or email address in the process of doing so. When that patient sends the blood test results to a virtual account address that includes that phone number or email address, the service will determine that the phone number or email address is already associated with a secure electronic message account. The service may then determine whether the patient information in the blood test results matches the patient information associated with the secure electronic message account. In this example, there will not be a match; the patient information associated with the secure electronic message account will describe the child, and the patient information in the blood test results will describe the patient. The service may then send an invite message to the email address or phone number, but may ask that the patient provide information that may be used to validate both the identity of the patient and the relationship of the patient to the child. Upon receiving this information and validating the identity and relationship, the service may create another secure electronic message account for the patient and create an association between the secure electronic message account for the patient and the secure electronic message account for the child.

In another scenario, the patient may have previously created a secure electronic message account but may have forgotten the email address for that account. The patient may again provide her phone number or other email address to the doctor, and the doctor may again send an email to a virtual account address which includes the phone number or email address. Upon receiving the email, the service may determine that the phone number or email address is associated with a secure electronic message account, and that the patient information in the blood test results matches the patient information associated with the secure electronic message account. The service may then send an email with the blood test results to the email address for the secure electronic message account. When the phone number or email address in the virtual account address is associated with multiple secure electronic message accounts (e.g., the above parent-child scenario), the service sends an email to the email address of whichever secure electronic message account matches the blood test results.

In a further scenario, the service may receive an email communicating a new prescription that the doctor would like the patient to take. Upon receiving the email, the service may compare the prescription to other medicines being taken by the patient. If there is a conflict, such as prescriptions that should not be taken together, the service may send an alert message to the doctor and may, in some cases, refrain from sending an invite message or email to the patient.

In another scenario, the doctor may wish to keep her email address private. In such cases, the service may use a conversation identifier instead of a doctor email address in the “from” line of the email to the secure electronic message account. The patient may reply to the email and conversation identifier, and the service may map the conversation identifier to the doctor email address and forward the patient communication to that doctor email address.

### Example Devices

FIG. 2 illustrates a component level view of a computing device 200 of the account creation service 102. As illustrated, the computing device 200 comprises a system memory 202 storing an account creation module 204, medical history/records 206, accounts 208, a web service 210, a receiving folder 212, a conversation module 214, an analysis module 216, and one or more modules and data 218. Also, the computing device 200 includes processor(s) 220, a removable storage 222, a non-removable storage 224, input device(s) 226, output device(s) 228, and communication connections 230 to one or more other computing devices 232.

In various examples, system memory 202 may be volatile (such as RAM), non-volatile (such as ROM, flash memory, etc.) or some combination of the two.

The account creation module 204 may implement any of the account creation functionality of the account creation service 102 described above in detail with regard to FIG. 1. For example, the account creation module 204 may receive the secure communication 104, send the invitation message 112, create a secure electronic message account, including validating an identity of the recipient 116 requesting the creation of the secure electronic message account, and provide the medical information 110 via the secure communication 120. The validating may include communicating with identity validators 122, the medical service provider 106, the recipient 116, or others. The account creation module 204 may also link secure electronic message accounts, create invitation messages 112 based on the secure communication 104 or based on the medical history/records 206, and interact with the medical history/records 206, the accounts 208, the web service 210, the recipient folder 212, the conversation module 214, the analysis module 216, and the modules and data 218.

The medical history/records 206 may represent any of the medical information, patient records, patient histories, medical communications, etc. that are received, stored, analyzed, or communicated by the account creation service 102 and described above in detail with regard to FIG. 1. For example, the medical history/records 206 may include the medical information 110 received in the secure communication 104.

The accounts 208 may represent any datastore or datastores of information associated patients or medical service providers that are maintained by the account creation service 102 described above in detail with regard to FIG. 1. For example, the accounts 208 may correspond to secure electronic message accounts, such as those created at the requests of recipients 114 or those used by medical service providers 106. Accounts 208 may additionally or instead correspond to virtual account addresses and may store the medical information 110 included in the secure communication 104.

The web service 210 may implement any of the web user interface functionality of the account creation service 102 described above in detail with regard to FIG. 1. For example, the web service 210 may present the medical service provider 106 with a web electronic messaging portal to enable the medical service provider 106 to draft and send the secure communication 104. Alternatively or additionally, the web service 210 may present the medical service provider 106 with representations of invitation messages 112 created by the account creation service 102 to enable the medical service provider 106 to select from and send the invitation messages 112 to enable recipients 116 to request creation of secure electronic message accounts. In further examples, the web service 210 may receive web service calls from a print driver of the medical service provider 106 communicating the secure communication 104. In additional examples, the web service 210 may deliver the invite message 112 through a user interface of, e.g., a web browser of the recipient 116. Also or instead, the web service 210 may receive recipient 116 requests (e.g., via a web page) for creation of a secure electronic message account, send validation challenges, and receive validation responses. The web service 210 may further provide the secure communication 120 (e.g., via a web email client, web browser, etc.). In such examples, the web service 210 may serve as an interface between the account creation module 204 and other devices 232, such as the recipient 116 or medical service provider 106.

The receiving folder 212 may receive and store the invitation messages 112 created by the account creation service 102 and described above in detail with regard to FIG. 1. The invitation messages 112 stored in the receiving folder 212 may be presented to the medical service provider 106 by the web service 210 to enable the medical service provider 106 to select from and choose to send one or more of the invitation messages 112.

The conversation module 214 may implement any of the identity obfuscation functionality of the account creation service 102 described above in detail with regard to FIG. 1. For example, the conversation module 214 may identify a sender of the invitation message 112, the secure communication 120, or both with a conversation identifier. Such a conversation identifier may be used to obfuscate the communication address of the medical service provider 106 that is sending the medical information 110.

The analysis module 216 may implement any of the medical information analysis functionality of the account creation service 102 described above in detail with regard to FIG. 1. For example, the analysis module 216 may compare the medical information 110 to information maintained in the medical history/records 206 to determine if an alert needs to be sent (e.g., the medical information references a new prescription that conflicts with a currently used prescription). The analysis module 216 may then send the alert to the medical service provider 106 or to other medical service provider(s).

The modules and data 218 may also comprise any sort of applications or platform components of the computing device 200, as well as data associated with such applications or platform components.

In some examples, the processor(s) 220 may be a central processing unit (CPU), a graphics processing unit (GPU), or both CPU and GPU, or any other sort of processing unit.

The computing device 200 may also include additional data storage devices (removable and/or non-removable) such as, for example, magnetic disks, optical disks, or tape. Such additional storage is illustrated in FIG. 2 by removable storage 222 and non-removable storage 224.

Non-transitory computer-readable media may include volatile and nonvolatile, removable and non-removable tangible, physical media implemented in technology for storage of information, such as computer readable instructions, data structures, program modules, or other data. System memory 202, removable storage 222 and non-removable storage 224 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the computing device 200. Any such non-transitory computer-readable media may be part of the computing device 200.

In various examples, input devices 226 may include any sort of input devices known in the art. For example, input devices 226 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

In some examples, the output devices 228 may include any sort of output devices known in the art, such as a display (e.g., a liquid crystal display), speakers, a vibrating mechanism, or a tactile feedback mechanism. Output devices 228 may also include ports for one or more peripheral devices, such as headphones, peripheral speakers, or a peripheral display.

Computing device 200 also contains communication connections 230 that allow the computing device 200 to communicate with other computing devices 232, such as device(s) of the medical service provider 106, the recipient 116, or the identity validators 122. As described above with reference to FIG. 1, these communication connections 228 may be secured in accordance with one or more standards, protocols, specifications, or techniques to enable secure communication among the devices.

FIG. 3 illustrates a component level view of a computing device 300 of a recipient 116 or a medical service provider 106. As illustrated, the computing device 300 comprises a system memory 302 storing one or more modules and data 304. Also, the computing device 300 includes processor(s) 306, a removable storage 308, a non-removable storage 310, input device(s) 312, output device(s) 314, and communication connections 316 to one or more other computing devices 318.

In various examples, system memory 302 may be volatile (such as RAM), non-volatile (such as ROM, flash memory, etc.) or some combination of the two. The modules and data 304 may implement any of the functionality of the medical service provider 106 or the recipient 116 described above in detail with regard to FIG. 1. For example, the modules and data 304 may be a print driver of a printer or other computing device of medical service provider 106. The modules and data 304 may also be or include a web browser, email client, electronic health record application, mobile application or other client application of the medical service provider 106. In further examples, the modules and data 304 may be or include a web browser, messaging client, email client, mobile application, or other application of the recipient 116. In additional examples, the modules and data 304 may be or include modules of a fax machine of the recipient 116. The modules and data 304 may also comprise any sort of applications or platform components of the computing device 300, as well as data associated with such applications or platform components.

In some examples, the processor(s) 306 may be a central processing unit (CPU), a graphics processing unit (GPU), or both CPU and GPU, or any other sort of processing unit.

The computing device 300 may also include additional data storage devices (removable and/or non-removable) such as, for example, magnetic disks, optical disks, or tape. Such additional storage is illustrated in FIG. 3 by removable storage 308 and non-removable storage 310.

Non-transitory computer-readable media may include volatile and nonvolatile, removable and non-removable tangible, physical media implemented in technology for storage of information, such as computer readable instructions, data structures, program modules, or other data. System memory 302, removable storage 308 and non-removable storage 310 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the computing device 300. Any such non-transitory computer-readable media may be part of the computing device 300.

In various examples, input devices 312 may include any sort of input devices known in the art. For example, input devices 312 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

In some examples, the output devices 314 may include any sort of output devices known in the art, such as a display (e.g., a liquid crystal display), speakers, a vibrating mechanism, or a tactile feedback mechanism. Output devices 314 may also include ports for one or more peripheral devices, such as headphones, peripheral speakers, or a peripheral display.

Computing device 300 also contains communication connections 316 that allow the computing device 300 to communicate with other computing devices 318, such as device(s) of the account creation service 102. As described above with reference to FIG. 1, these communication connections 316 may be secured in accordance with one or more standards, protocols, specifications, or techniques to enable secure communication among the devices.

### Example Processes

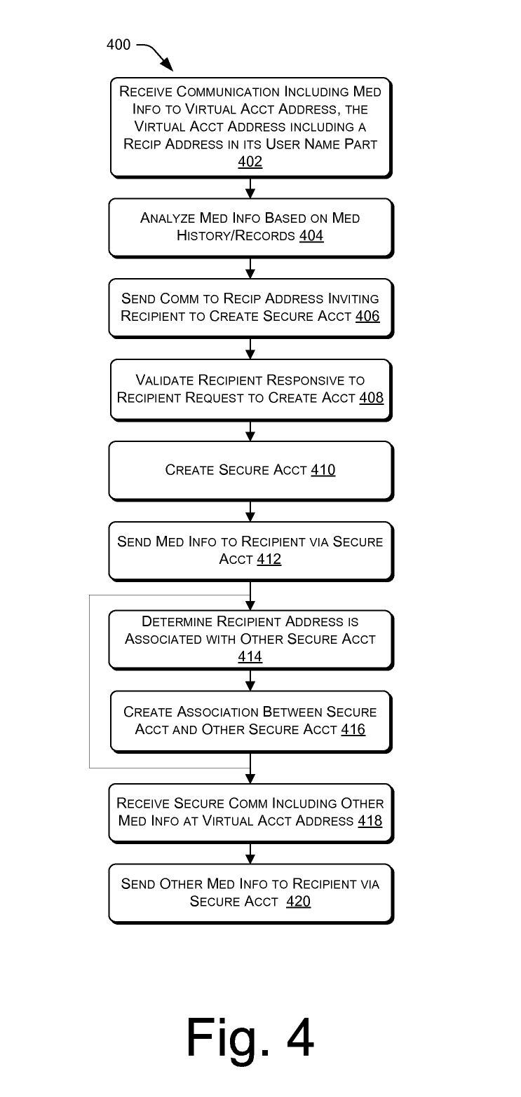

FIGS. 4-7 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 4 illustrates an example process for receiving a first communication to a virtual account address and sending a second communication to a recipient communication address that was included in the virtual account address. The process 400 may include, at 402, receiving, by one or more computing devices, a first communication sent to a virtual account address. The virtual account address may include a recipient communication address in a user name part of the virtual account address. Further, the first communication may be received from a medical service provider and the first communication may include or be associated with content for patient of the medical service provider or a person responsible for the care of the patient, such as medical information of the recipient. Alternative, the recipient may be a medical service provider, and the first communication may be received from a patient of the medical service provider, from another medical service provider, or from another party. Also, the recipient communication address may be one of a phone number, an email address, a transformed email address, a fax number, or a social media identifier of the patient, responsible person, or other recipient party.

At 404, the one or more computing devices may analyze the content of the first communication (e.g., medical information) based on a medical history of the recipient and may generate an alert based at least in part on the analysis. Such analysis may occur at any point in time following receipt of the first communication.

At 406, the one or more computing devices may send a second communication to the recipient communication address. The second communication may invite a recipient of the second communication, such as the patient, responsible person, or other recipient party, to request creation of a secure electronic message account to receive the content associated with or included in the first communication. The second communication may be one of a text message, an electronic message, a fax, a web portal, or a direct notification to a mobile application. In some examples, sending the second communication comprises sending an interactive voice response message to the recipient communication address requesting entry of an electronic message address and sending the second communication to the electronic message address. In further examples, the second communication may utilize a conversation identifier as a sender identifier to protect a communication address of a sender of the first communication.

At 408, the one or more computing devices may validate an identity of the recipient responsive to input from the recipient requesting creation of the secure electronic message account. In some examples, the validating comprises validating the identity of the recipient based on information included in the secure content associated with the first communication, based on other information provided by a sender of the first communication, or based on records for the recipient. In further examples, the validating comprises receiving a first photo or a first biometric from the recipient and validating the identity of the recipient based on a comparison of the first photo or the first biometric to a second photo or a second biometric included in the first communication or stored in associated with a recipient record. In additional examples, the validating comprises providing validation input received from the recipient to a third party service and receiving validation of identity from the third party service (e.g., from a carrier phone number lookup) or providing validation input received from the recipient to a sender of the first communication to request the sender to verify the identity of the recipient based on the validation input. Also, in some examples, the validating comprises requesting that the recipient provide at least one of a name, a gender, a date of birth, an address, a zip code, medical history information, or other private information.

At 410, upon validating the identity of the recipient, the one or more computing devices may create the secure electronic message account.

At 412, responsive to creating the secure electronic message account, the one or more computing devices may provide the content associated with or included in the first communication to the recipient via the secure electronic message account.

At 414, either upon receipt of the first communication, upon creating the secure electronic message account, or at a time there between, the one or more computing devices may determine that the recipient communication address is associated with another secure electronic message account. Such a determination may include determining that the patient mentioned in the content of the first communication differs from the person associated with the other secure electronic message account. This may be because the person associated with the other secure electronic message account is under care of the patient or is a person responsible for the care of the patient (e.g., parent and young child or adult child and elderly parent). Upon making such a determination, the one or more computing devices may, at 412, create the secure electronic message account for the patient and, at 416, create an association between the secure electronic message account and the other secure electronic message account. In some examples, creating the association is performed conditionally based on confirmation by the recipient that the person referenced by the other secure electronic message account is associated with the recipient.

At 418, the one or more computing devices may receive a third communication to the virtual account address after creation of the secure electronic message account. At 420, the one or more computing devices may then send content associated with the third communication to the secure electronic message account. When the virtual account address is associated with both the secure electronic message account and another secure electronic message account, the one or more computing devices may determine a name of a patient, responsible person, or other recipient party referenced in the content associated with the third communication and send the content to whichever secure electronic message account is associated with the name.

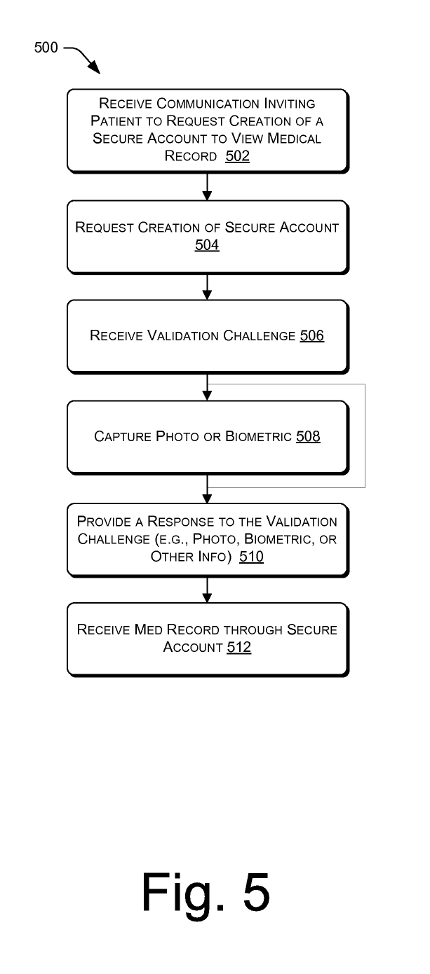

FIG. 5 illustrates an example process for receiving a communication inviting its recipient to request creation of a secure electronic message account to receive a medical record, requesting creation of the secure electronic message account, receiving a validation challenge, providing an answer to the validation challenge, and receiving the medical record through the secure electronic message account. The example process 500 may include, at 502, a recipient device receiving a communication inviting a recipient to request creation of a secure electronic message account to view a medical record of the recipient. The recipient may be the patient referenced by the medical record or a person responsible for the care of the patient. The communication may be one of a text message, an electronic message, or a fax, or may be received via a web portal.

At 504, the recipient device may request creation of the secure electronic message account. In some examples, the communication may be received as a fax with a bar code and the requesting may include requesting creation of the secure electronic message account through a web portal and providing the bar code through the web portal.

At 506, the recipient device may receive a validation challenge seeking information associated with the medical record.

At 508, the recipient device may then capture a photo or biometric.

At 510, the recipient device may provide a response from the recipient to the validation challenge. The response may include the captured photo or biometric. The response may also or instead include at least one of a name, a gender, a date of birth, an address, a zip code, medical history information, or other private information.

At 512, the recipient device may receive the medical record via the secure electronic message account responsive to a determination that the response to the validation challenge matches the information associated with the medical record.

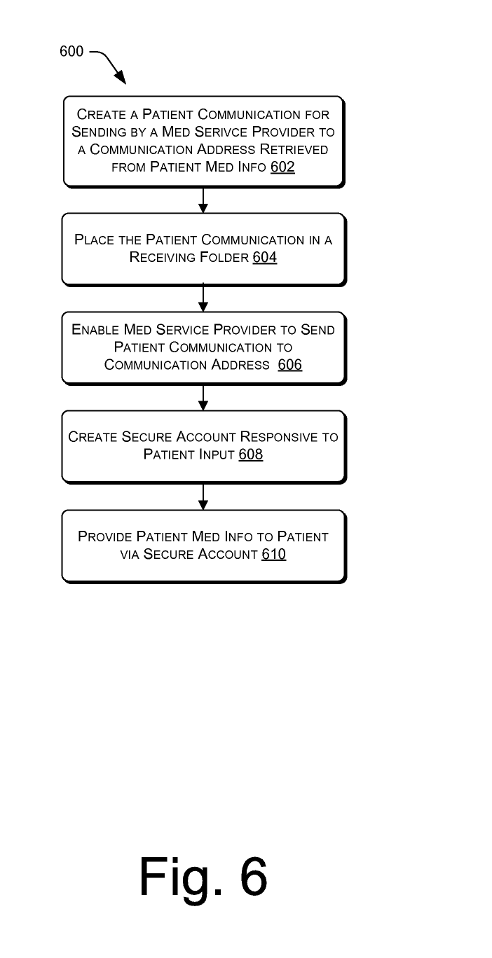

FIG. 6 illustrates an example process for creating a patient communication that invites the patient to create a secure electronic message account to receive patient medical information, enabling a medical service provider to send the patient communication, creating the secure electronic message account responsive to patient input, and providing the patient medical information to the patient via the secure electronic message account. The example process 600 includes, at 602, creating, by one or more computing devices, a patient communication for sending by a medical service provider to a communication address retrieved from medical information of the patient. The communication address may be an address for the patient or for a person responsible for care of the patient. The patient communication may invite the patient or responsible person to request creation of a secure electronic message account to view the medical information.

At 604, the one or more computing devices may place the patient communication in a receiving folder for created patient communications.

At 606, the one or more computing devices may enable the medical service provider to send the patient communication to the communication address.

At 608, the one or more computing devices may create the secure account responsive to input from the patient or responsible person.

At 610, the one or more computing devices may provide the medical information to the patient or responsible person via the secure electronic message account.

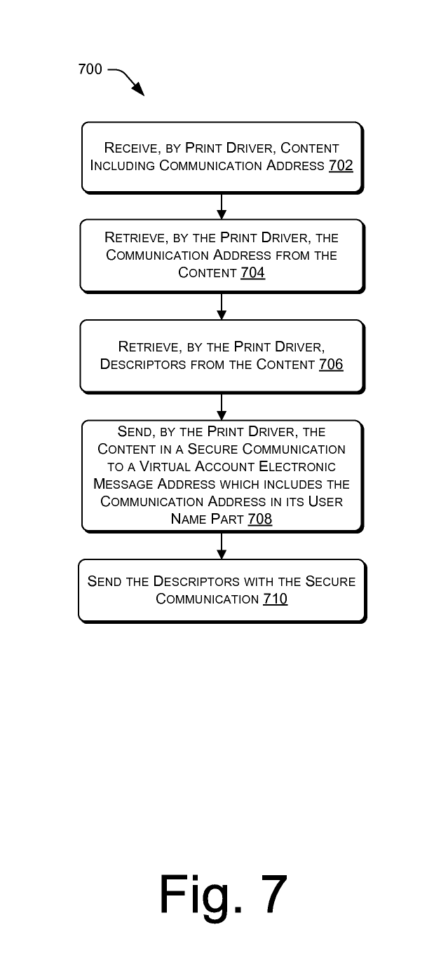

FIG. 7 illustrates an example process for a print driver to receive content that includes a communication address, to retrieve the communication address from the content, and to send the content in a secure communication to a virtual account address that include the communication address in a user name part of the virtual account address. The example process 700 includes, at 702, a print driver receiving content that includes a communication address. The content may be medical information of a patient.

At 704, the print driver may retrieve the communication address from the content. The communication address may be a communication address of a patient or of a person responsible for care of the patient.

At 706, the print driver may also retrieve descriptors of the patient from the medical information.

At 708, the print driver may send the content in a secure communication to a virtual account address. The virtual account address may include the communication address in a user name part of the virtual account address. In some examples, the sending may involve sending the secure communication through an electronic message or a web service call.

At 710, the print driver may provide the descriptors with the secure communication.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
one or more processors; and
an account creation module configured to be operated by the one or more processors to perform operations including:
receiving a secure communication sent to a virtual account address, the secure communication including medical information for a patient and the virtual account address including a phone number for the patient in a user name part of the virtual account address;
sending a communication to the phone number, the communication to the phone number inviting the patient to request creation of a secure electronic message account to receive the medical information;
creating the secure electronic message account responsive to input from the patient, the creating including validating an identity of the patient; and
responsive to creating the secure electronic message account, providing the medical information to the patient via the secure electronic message account.

2. The system of claim 1, wherein the validating comprises requesting that the patient provide at least one of a name, a gender, a date of birth, an address, a zip code, medical history information, a photo, a biometric, or other private information.

3. The system of claim 1, wherein the validating includes:
performing a carrier phone number lookup to retrieve an identity associated with the phone number by a carrier,
comparing validation input received from the patient to the medical information, or
providing validation input received from the patient to a third party service and receiving validation of the identity of the patient from the third party service.

4. A computer-implemented method comprising:
receiving a first communication sent to a virtual account address, the virtual account address including a recipient communication address in a user name part of the virtual account address; and
sending a second communication to the recipient communication address, the second communication inviting a recipient of the second communication to request creation of a secure electronic message account to receive content associated with the first communication.

5. The computer-implemented method of claim 4, wherein the recipient communication address is one of a phone number, an email address, a transformed email address, a fax number, or a social media identifier.

6. The computer-implemented method of claim 4, wherein the second communication is one of a text message, an electronic message, a fax, a web portal, or a direct notification to a mobile application.

7. The computer-implemented method of claim 4, wherein sending the second communication comprises sending an interactive voice response message to the recipient communication address requesting entry of an electronic message address and sending the second communication to the electronic message address.

8. The computer-implemented method of claim 4, wherein the first communication is received from a medical service provider of the recipient and the content associated with the first communication is medical information of the recipient.

9. The computer-implemented method of claim 8, further comprising analyzing the medical information based on a medical history of the recipient and generating an alert based at least in part on the analysis.

10. The computer-implemented method of claim 4, wherein the recipient is a medical service provider.

11. The computer-implemented method of claim 4, wherein the second communication utilizes a conversation identifier as a sender identifier to protect a communication address of a sender of the first communication.

12. The computer-implemented method of claim 4, further comprising:
creating the secure electronic message account responsive to input from the recipient; and
responsive to creating the secure electronic message account, providing the content associated with the first communication to the recipient via the secure electronic message account.

13. The computer-implemented method of claim 12, further comprising determining that the recipient communication address is associated with another secure electronic message account and creating an association between the secure electronic message account and the other secure electronic message account.

14. The computer-implemented method of claim 13, further comprising, subsequent to creating the secure electronic message account, receiving a third communication to the virtual account address and sending content associated with the third communication to either the secure electronic message account or the other secure electronic message account based on a name included in the content associated with the third communication.

15. The computer-implemented method of claim 13, wherein creating the association is performed conditionally based on confirmation by the recipient that a person referenced by the other secure electronic message account is associated with the recipient.

16. The computer-implemented method of claim 12, wherein the creating includes validating an identity of the recipient.

17. The computer-implemented method of claim 16, wherein the validating comprises validating the identity of the recipient based on information included in the content associated with the first communication or based on other information provided by a sender of the first communication.

18. The computer-implemented method of claim 16, wherein the validating comprises validating the identity of the recipient based on records for the recipient.

19. The computer-implemented method of claim 16, wherein the validating comprises receiving a first photo or a first biometric from the recipient and validating the identity of the recipient based on a comparison of the first photo or the first biometric to a second photo or a second biometric included in the first communication or stored in associated with a recipient record.

20. The computer-implemented method of claim 16, wherein the validating comprises providing validation input received from the recipient to a third party service and receiving validation of the identity of the recipient from the third party service.

21. The computer-implemented method of claim 16, wherein the validating comprises providing validation input received from the recipient to a sender of the first communication to request the sender to verify the identity of the recipient based on the validation input.

22. The computer-implemented method of claim 16, wherein the validating comprises requesting that the recipient provide at least one of a name, a gender, a date of birth, an address, a zip code, medical history information, or other private information.

23. The computer-implemented method of claim 12, further comprising, subsequent to creating the secure electronic message account, receiving a third communication to the virtual account address and sending content associated with the third communication to the secure electronic message account.

24. One or more non-transitory computer-readable media having stored thereon computer-executable instructions configured to program a computing device to perform operations comprising:
receiving a communication inviting a recipient to request creation of a secure electronic message account to view a medical record of the recipient;
requesting creation of the secure electronic message account;
in response to the requesting, receiving a validation challenge seeking information associated with the medical record;
providing a response from the recipient to the validation challenge; and
receiving the medical record via the secure electronic message account responsive to a determination that the response to the validation challenge matches the information associated with the medical record.

25. The one or more non-transitory computer-readable media of claim 24, wherein receiving the communication comprises receiving the communication as one of a text message, an electronic message, a fax, or a web portal.

26. The one or more non-transitory computer-readable media of claim 24, wherein
receiving the communication comprises receiving the communication as a fax with bar code, and
requesting creation of the secure electronic message account comprises requesting creation of the secure electronic message account through a web portal, including providing the bar code through the web portal.

27. The one or more non-transitory computer-readable media of claim 24, wherein providing the response comprises providing at least one of a name, a gender, a date of birth, an address, a zip code, medical history information, or other private information.

28. The one or more non-transitory computer-readable media of claim 24, wherein
the operations further comprise capturing a photo or a biometric of the recipient, and
providing the response comprises providing the captured photo or biometric.

29. A computer-implemented method comprising:
creating a patient communication for sending by a medical service provider to a communication address for the patient retrieved from medical information of the patient, the patient communication inviting the patient to request creation of a secure electronic message account to view the medical information;
enabling the medical service provider to send the patient communication to the communication address;
creating the secure electronic message account responsive to input from the patient; and
responsive to creating the secure electronic message account, providing the medical information to the patient via the secure electronic message account.

30. The computer-implemented method of claim 29, further comprising, prior to enabling the medical service provider to send the patient communication, placing the patient communication in a receiving folder for created patient communications.

31. The computer-implemented method of claim 29, wherein enabling the medical service provider to send the patient communication comprises providing a user interface which displays a representation of the patient communication to the medical service provider.

32. A system comprising:
one or more processors;
a print driver configured to be operated by the one or more processors to perform operations including:
receiving content that includes a communication address;
retrieving the communication address from the content; and
sending the content in a secure communication to a virtual account address, the virtual account address including the communication address in a user name part of the virtual account address.

33. The system of claim 32, wherein sending the content in the secure communication comprises sending the secure communication through an electronic message or a web service call.

34. The system of claim 32, wherein the content is medical information and the operations further include retrieving descriptors of a patient associated with the communication address from the medical information and providing the descriptors with the secure communication.
